(19) United States
(12) Patent Application Publication
(10) Pub. No.: US 2015/0052800 A1
(43) Pub. Date: Feb. 26, 2015

(54) PARASITE ELIMINATION SYSTEM AND METHOD

(71) Applicants: Robert N. Timbrook, JR., Woodstock, GA (US); Kevin Haim, Canton, GA (US); Geoff Haim, Nazareth, PA (US)

(72) Inventors: Robert N. Timbrook, JR., Woodstock, GA (US); Kevin Haim, Canton, GA (US); Geoff Haim, Nazareth, PA (US)

(21) Appl. No.: 13/971,388

(22) Filed: Aug. 20, 2013

(51) Int. Cl. A01M 1/20

(52) U.S. Cl. CPC A01M 1/2094
USPC 43/132.1; 43/124

(57) ABSTRACT

The present invention relates generally to systems and methods for eliminating parasites and parasitic insects. More particularly, the present invention relates to a method for eliminating parasitic insects, such as bed bugs through use of uniform directional heating. In exemplary embodiments of the present invention, radiant heat is used over a designated period of time (e.g., cleaning cycle) in order to eliminate parasites in a contaminated area enveloped by a blanket like structure.

### CROSS-REFERENCE TO RELATED APPLICATIONS

This application claims the benefit of the following provisional patent application which is hereby incorporated by reference in its entirety: 61/684,951 filed Aug. 20, 2012, the entire disclosure of which is incorporated herein by reference.

### FIELD OF THE INVENTION

The present invention relates generally to systems and methods for eliminating parasites and parasitic insects. More particularly, the present invention relates to a method for eliminating parasitic insects, such as bed bugs through use of uniform directional heating.

### BACKGROUND

Bed bug infestations has become a serious concern in numerous industries, including the hotel and hospitality industries. These infestations have become rampant, with serious consequences for business and residential operations. Bed bugs, and other parasites that live in or on surfaces or objects that routinely come in contact with humans, can cause serious health concerns as their bites and cimicosis may lead to the transmission of numerous pathogens.

The occurrence, population and expansion of habitats has been on the rise for the past two decades. While elimination of man of these pests can be done via chemical or other toxic pesticide treatment means, these means are generally not recommended where the treated objects are to be used or in contact with the general human population due to toxicity levels of these treatments. In general, non-toxic treatment means are preferred in these cases.

Since infestations of these parasites are commonly found in residential and commercial establishments that are frequented by numerous individuals, such as hotels, motels, and other rental properties, it would be desirable to have non-toxic treatment means that could be used onsite. However, currently, most treatment means either involve either using pesticides or using off-site treatment means.

Therefore, there is a need in the art for a parasite elimination system and method that is portable and can eliminate parasites with non-toxic means. These and other features and advantages of the present invention will be explained and will become obvious to one skilled in the art through the summary of the invention that follows.

### SUMMARY OF THE INVENTION

Accordingly, it is an aspect of the present invention to provide a parasite elimination system and method that is portable and can eliminate parasites with non-toxic means.

According to an embodiment of the present invention, a system for eliminating parasites and parasitic insects includes: a radiant heat source comprising a blanket like structure and a heating element incorporated within or the blanket like structure such that radiant heat is passed evenly over a surface of the blanket like structure; and a control unit operably connected to said radiant heat source and configured to engage parasite elimination cleaning cycles.

According to an embodiment of the present invention, the blanket like structure comprises one or more blanket sections, wherein each of said one or more blanket sections may be disconnected from the other blanket sections.

According to an embodiment of the present invention, each of the one or more blanket sections comprises one or more securing elements configured to allow first blanket section of the one or more blanket sections to be secured to a second blanket section.

According to an embodiment of the present invention, the system may further include a housing that is configured to envelop the blanket like structure to secure a contaminated area defined inside the blanket like structure such that parasites cannot escape from the contaminated area during a cleaning cycle.

According to an embodiment of the present invention, the housing comprises a flexible non-porous material.

According to an embodiment of the present invention, the housing is constructed from a non-porous flame retardant material.

According to an embodiment of the present invention, the housing comprises a light weight flexible material.

According to an embodiment of the present invention, the control unit further includes control elements allowing for the modification of settings selected from the group comprising temperature range, cleaning cycle time, type of cleaning cycle, type of parasite or parasitic insect targeted and type of area to be cleaned.

According to an embodiment of the present invention, the control unit further includes a temperature probe, allowing for accurate measurement of the temperatures inside the system during a cleaning cycle.

According to an embodiment of the present invention, a method for eliminating parasites and parasitic insects includes the steps of: placing a blanket like structure over a contaminated area; engaging a heating element of the blanket like structure such that the surface of the blanket that is in contact with the contaminated area receives radiant heat to an extent great enough to raise a temperature in the contaminated area high enough to kill parasites and parasitic insects within the contaminated area while not damaging other contents of the contaminated area; and applying the radiant heat from the system for a time period set by and controlled via a control unit, wherein the time period is great enough to kill the parasites and parasitic insects in the contaminated area.

According to an embodiment of the present invention, the method further includes the step of securing the blanket like structure in place over the contaminated area so that the area is completely enveloped within the blanket like structure.

According to an embodiment of the present invention, the temperature is greater than 46 degrees Celsius.

According to an embodiment of the present invention, the temperature is between 115 degrees Fahrenheit and 160 degrees Fahrenheit.

According to an embodiment of the present invention, the time period is between 7 and 60 minutes.

According to an embodiment of the present invention, the time period is greater than 7 minutes.

According to an embodiment of the present invention, the method further includes the steps of: determining, via a temperature probe operably attached to the control unit, an ambient temperature in said contaminated area; and delaying start of said time period until said ambient temperature meets or exceeds said temperature.

According to an embodiment of the present invention, the method further includes the steps of modifying one or more settings of said control unit via one or more control elements.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

Referring to the drawings, wherein like reference numerals are used to designate like parts:

FIG. 1 shows views of an exemplary embodiment of a parasite elimination system in accordance with an embodiment of the present invention;

FIG. 2 shows views of an exemplary embodiment of a control unit as used in a parasite elimination system in accordance with an embodiment of the present invention;

FIG. 3 shows views of an exemplary embodiment of a control unit as used in a parasite elimination system in accordance with an embodiment of the present invention;

FIG. 4 shows views of an exemplary embodiment of a housing as used in a parasite elimination system in accordance with an embodiment of the present invention;

FIG. 5 shows views of an exemplary embodiment of a sealing element as used in a parasite elimination system in accordance with an embodiment of the present invention;

FIG. 6 shows views of an exemplary embodiment of a parasite elimination system in accordance with an embodiment of the present invention;

FIG. 7 shows views of an exemplary embodiment of a parasite elimination system in accordance with an embodiment of the present invention;

FIG. 8 shows views of an exemplary embodiment of a parasite elimination system in accordance with an embodiment of the present invention; and

FIG. 9 shows views of an exemplary embodiment of a parasite elimination system in accordance with an embodiment of the present invention.

### DETAILED SPECIFICATION

According to an embodiment of the present invention, a system and method for eliminating parasites and parasitic insects is provided. In a preferred embodiment of the present invention, the parasite elimination system is comprised of a radiant heat source configured to envelop an area contaminated with parasites and/or parasitic insects, such as bed bugs.

In a preferred embodiment of the present invention, the radiant heat source may be comprised of a blanket like structure that has a heating element incorporated in or on the blanket like structure such that radiant heat is passed evenly over the surface of the blanket like structure.

According to an embodiment of the present invention, the blanket like structure is configured to be placed over or on a contaminated area such that the entire area is enveloped within or under the blanket like structure. This prevents the parasites and parasitic insects from escaping into the surrounding areas during a treatment cycle. The blanket like structure may be constructed from materials that are durable and reusable and capable of withstanding repeated exposures to increased temperatures and wide variance in temperatures including rapid heating and cooling cycles. Materials include, but are not limited to vinyl, plastics, carbon fiber, rubber or any combination thereof. One of ordinary skill in the art would appreciate that there are numerous materials that could be used in the blanket like structure, and embodiments of the present invention are contemplated for use with any appropriate material capable of withstanding the repeated abuse required by embodiments of the present invention.

According to an embodiment of the present invention, the blanket like structure may be comprised of one or more blanket sections. Blanket sections may be attached and removed from one another, allowing for the blanket like structure to be increased or decreased in size for use in varying applications.

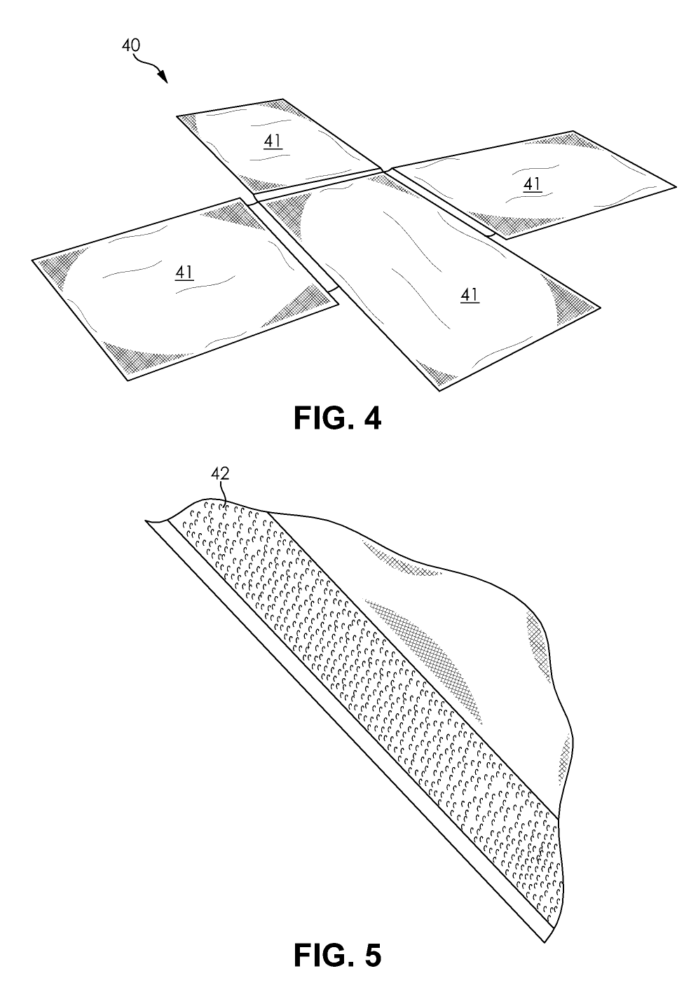

According to an embodiment of the present invention, the blanket like section may be further covered with a housing that is configured to secure the contaminated area/materials such that the parasites and/or parasitic insects cannot escape from the area during a cleaning cycle. The housing may be, for instance, a flexible non-porous material that is configured to seal around the contaminated area. In a preferred embodiment, the housing may be constructed from a non-porous flame retardant material that is light weight and easy to handle, allowing for flexibility in covering the contaminated area. In a preferred embodiment, the housing may be comprised of multiple sections of such non-porous flame retardant material such that the sections fold into a housing (see FIGS. 4-8) and are configured to adjoin via one or more securing elements in such a manner that creates a seal through which the parasites and/or parasitic insects cannot escape. Securing elements, may include, but are not limited to, Velcro, zippers, heat seals and Ziploc type seals. One of ordinary skill in the art would appreciate that there are numerous types of securing elements that may be utilized with embodiments of the present invention, and embodiments of the present invention are contemplated for use with any type of securing elements.

In alternate embodiments, the housing may be a rigid structure that is configured to receive contaminated elements therein. For instance, the housing may be a structure that is configured to receive one or more bags. Once the bags are inserted into the housing, the housing may be sealed (e.g., via a door or other opening) and the cleaning cycle may ensue. One of ordinary skill in the art would appreciate that there are numerous types of housings that may be utilized with embodiments of the present invention, and embodiments of the present invention are contemplated for use with any type of housing.

According to an embodiment of the present invention, the heating element may be comprised of numerous heating coils or other heating means incorporated in or on the blanket like structure. In a preferred embodiment of the present invention, the heating element(s) are incorporated directly within the blanket like structure. In other embodiments, the heating elements may be attached to one side of a blanket like structure. Heating elements may include, but are not limited to, band heaters, cartridge heaters, bolt heaters, formed/finned tubular heaters, or any combination thereof. One of ordinary skill in the art would appreciate that there are numerous types of heating elements that could be utilized with embodiments of the present invention, and embodiments of the present invention are contemplated for use with any type of heating element.

According to an embodiment of the present invention, the heating element may be further comprised of a power source. The power source is configured to provide power to the heating element in a manner that allows the heating element to convert the power into heat. In a preferred embodiment of the present invention, the power source may be an AC or DC power adapter, configured to be plugged into a standard power outlet without requiring any modification to the circuitry or other electronics providing general power transmission. This allows the heating element to be utilized in a wide variety of settings, including residential settings and light commercial settings. In other embodiments, the power source may be comprised of one or more batteries. In a preferred embodiment, the power source of the heating element may be connected to a control unit, allowing the control unit to control timing and duration of cleaning cycles. One of ordinary skill in the art would appreciate that there are numerous power sources that could be utilized with embodiments of the present invention, and embodiments of the present invention are contemplated for use with any type of power source.

According to an embodiment of the present invention, the blanket like structure may be constructed in such a manner that the heat from the heating element is provided in a unidirectional manner (i.e., directed towards the contaminated area only). In this manner, the blanket like structure may remain safe to the touch on the side of the blanket like structure that does not face the contaminated area. This may be accomplished, for instance, by having a non-conductive or heat resistant material on the exterior side of the blanket that does not face the contaminated area. One of ordinary skill in the art would appreciate that there are numerous methods for providing directional heating, and embodiments of the present invention are contemplated for use with any method for providing directional heating.

According to an embodiment of the present invention, the method for eliminating parasites and/or parasitic insects from a contaminated area is comprised of (1) placing the blanket like structure over a contaminated area and optionally securing the blanket like structure in place over the contaminated area so that the area is completely enveloped within the blanket like structure; (2) engaging the heating element of the blanket like structure such that the surface of the blanket that is in contact with the contaminated area receives radiant heat to the extent great enough to kill the parasites and parasitic insects within the contaminated area while not damaging the material of the contaminated area; (3) applying the radiant heat from the system for a time period great enough to kill the parasites and parasitic insects in the material.

Preferred embodiments of the present invention may be configured to target and kill parasites and parasitic insects in a specific contaminated area. Advantageously, small areas or specific items, pieces of furniture or other defined spaces may be targeted, allowing the surrounding areas to remain in use. This can be particularly advantageous when the contaminated area is in a high traffic area (e.g., airports, hotel lobbies, hotel rooms, restaurants). In this manner, the surrounding area can still be utilized for its intended purpose, even while cleaning of the contaminated area is occurring.

Certain embodiments of the present invention can enhance this effect by providing an exterior appearance that is nondescript or otherwise does not draw attention to itself, thereby not creating alarm or concern in bystanders, patrons or other individuals in the area. This further allows embodiments of the present invention to be utilized even during normal operation or business hours.

According to an embodiment of the present invention, the system may be configured to raise the temperature of the contaminated area to a high enough level required to kill any parasites and parasitic insects within the area. For instance, the system may be configured to raise the temperature, radiantly without any moving air or circulation of heat via fan or other device, to at least 46 degrees Celsius (115 degrees Fahrenheit). Certain embodiments of the present invention may be able to raise the temperature to levels higher than the above referenced temperature. Further embodiments of the present invention are configured to be adjustable to allow for specific temperatures or temperature ranges to be maintained and/or reached. In one embodiment, a system may be configured to provide variable temperature control ranging from ambient temperatures to 160 degrees Fahrenheit. In a preferred embodiment of the present invention, the system may be configured to maintain an ambient internal temperature of 120-130 degrees Fahrenheit. Temperature requirements may be based on the type of parasite or parasitic insect targeted by particular embodiments (e.g., lethal temperature/time duration for bed bug adults & nymphs 113° F./45° C./15 minutes, bed bug eggs 113° F./45° C./60 minutes, bed bug all stages 115° F./46° C. 7 minutes). One of ordinary skill in the art would appreciate that there are numerous temperatures that may be utilized with embodiments of the present invention, and embodiments of the present invention re contemplated for use with any temperature.

According to an embodiment of the present invention, the system may be further comprised of a control unit configured to allow a user the ability to adjust one or more settings of the system and start/stop cleaning cycles. In certain embodiments, the control unit may be configured to receive power from the power source and may be configured to allow the user to adjust settings, such as temperature range, cleaning cycle time, type of cleaning cycle, type of parasite or parasitic insect targeted and type of area to be cleaned (e.g., bed, rug, chair, clothing). The control unit may be further comprised of a temperature probe, allowing for accurate measurement of the temperatures inside the system during a cleaning cycle.

According to an embodiment of the present invention, the system may be configured to ramp up and down the heat in various manners. For instance, the system may be configured to allow for the heat to be ramped up quickly, allowing for the contaminated area to be heated quickly. In other embodiments of the present invention, the system may be configured to be timed specifically for specified applications (e.g., eliminate bed bugs, eliminate all parasite types) and contaminated area types (e.g., standard king size bed, twin bed, memory foam mattress, rug, clothing). In this manner, the system can be configured for varying use, depending on the present need of the user.

According to an embodiment of the present invention, the system may be configured to provide pre-configured treatment cycles, allowing for the user to set the system on or over a contaminated area and select the exact treatment cycle type. In this manner, the system may be configured for easy application on common contaminated area types (e.g., beds).

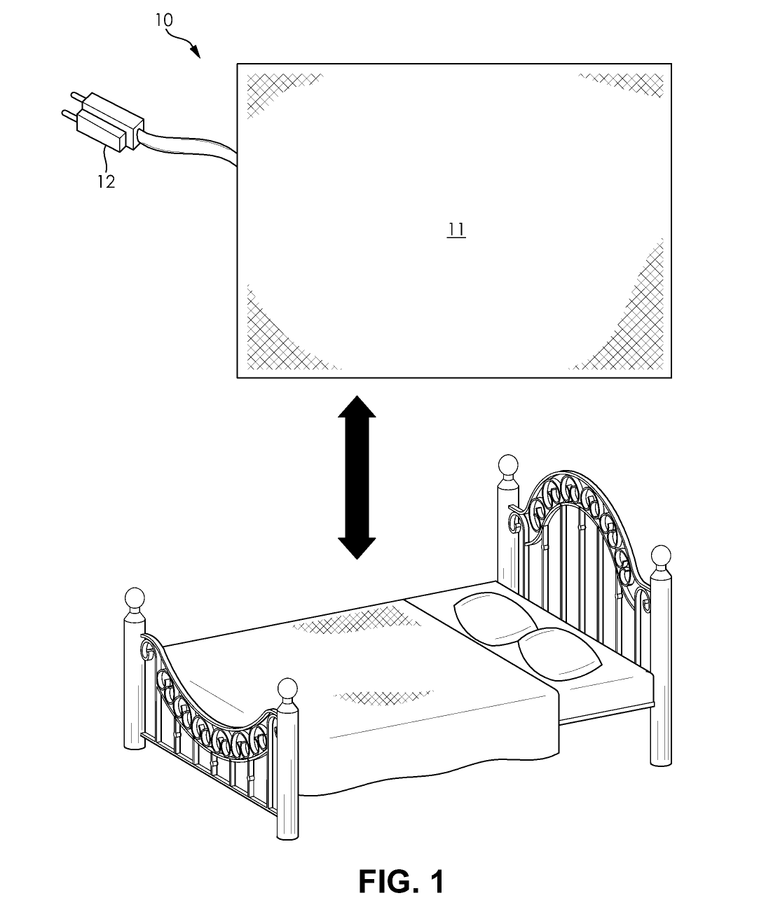

Turning now to FIG. 1, views of an exemplary embodiment of a system, in accordance with an embodiment of the present invention, is shown. In this embodiment, the system 10 is a blanket like structure 11 that is sized appropriately for use on a contaminated area that is a standard size bed. In use, the blanket like structure will be placed over the bed and the power source 12 will be plugged into a standard wall outlet in order to provide power to the heating element integrated into the blanket like structure 11.

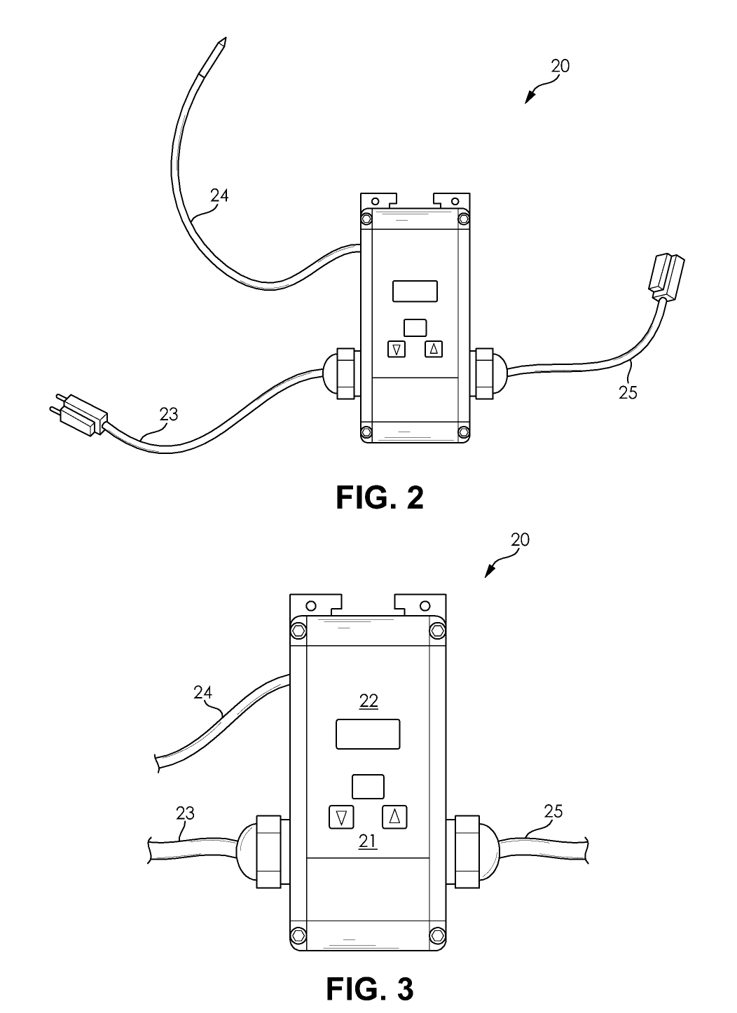

Turning now to FIGS. 2-3, views of a control unit in accordance with an exemplary embodiment of the system, are shown. In this embodiment, a controller is comprised of a user interface with control buttons 21 and display 22, power source connections (in from standard wall source 23 and out to heating element(s) 25) and a temperature probe 24.

Turning now to FIGS. 4-8, views of the system in various stages of use, are shown. FIG. 4 shows a housing 40 laid out flat and ready to receive a contaminated item or area to be received upon it. In this view, four housing sections 41 are attached via securing elements 42, allowing for a larger containment area than would be possible with only one housing section.

FIG. 5 shows a detailed view of a sealing element attached to one side of a housing. In this case, the sealing element is a hook and loop fastener (i.e., Velcro®). As noted above, the housings could utilize any number of securing elements, and embodiments of the present invention are contemplated for use with any number of securing elements.

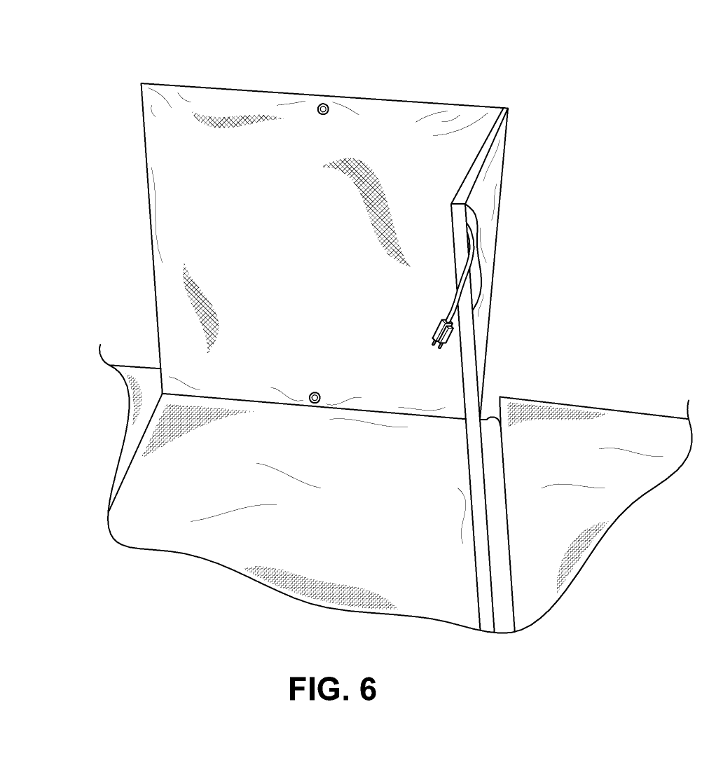

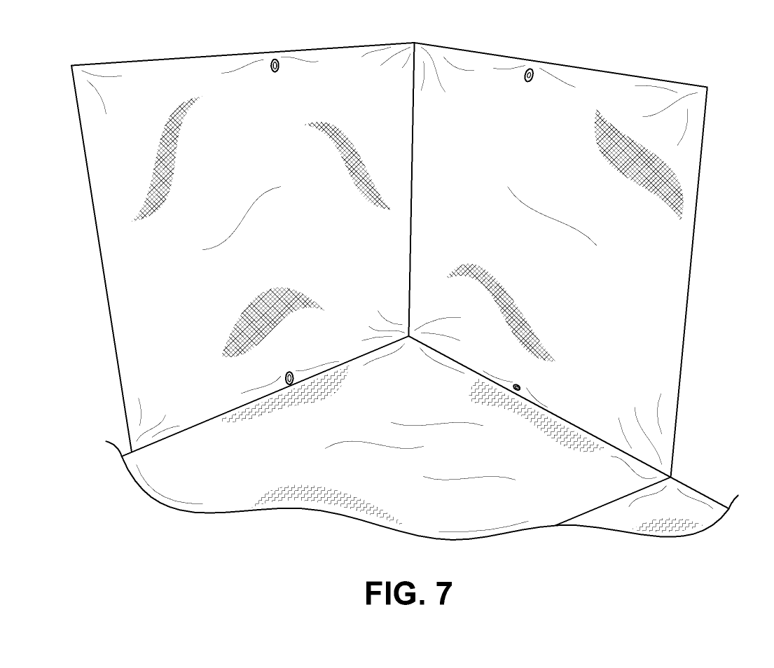

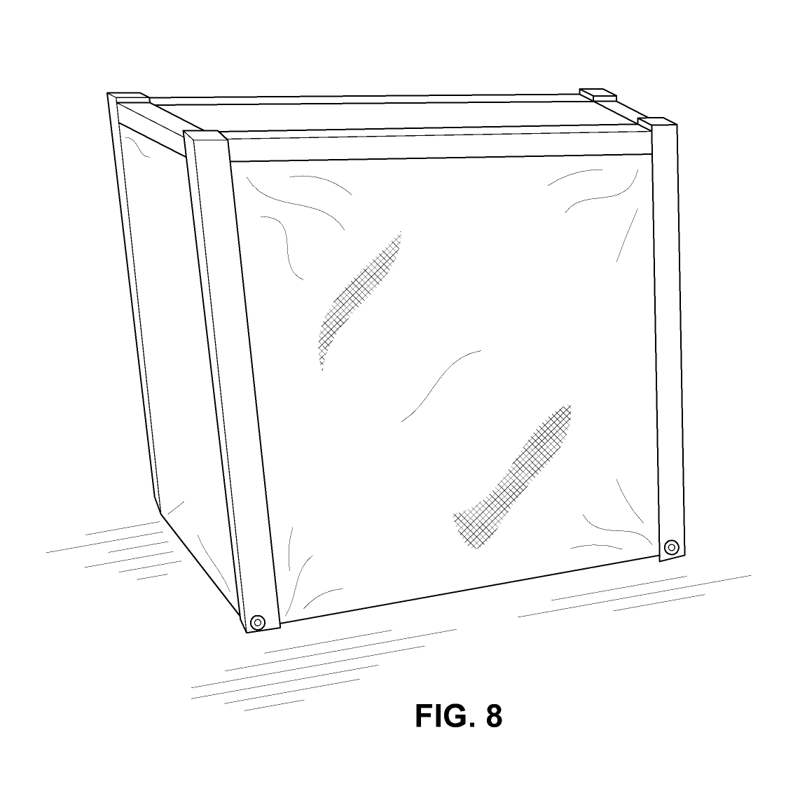

FIGS. 6-7 show the blanket like structures being folded up into a box-like shape for treating the area inside. FIG. 8 shows the entire system folded into a box-like structure for use in cleaning the contaminated area inside the box-like structure. Around the outside of the folded blanket like structure is the housing, sealed with the sealing elements, preventing any escape by the parasites and parasitic insects contained within. While a box-like structure shown in the figures is substantially rectangular, one of ordinary skill in the art would appreciate that any shape could be constructed using one or more blanket like structures and one or more housing sections to create shapes for specific needs, such as varying bed sizes (e.g., twin, full, queen, king, California king) and varying object sizes. Embodiments of the present invention are contemplated for use with any number of blanket like structures and housing sections to allow for any shape box-like structures.

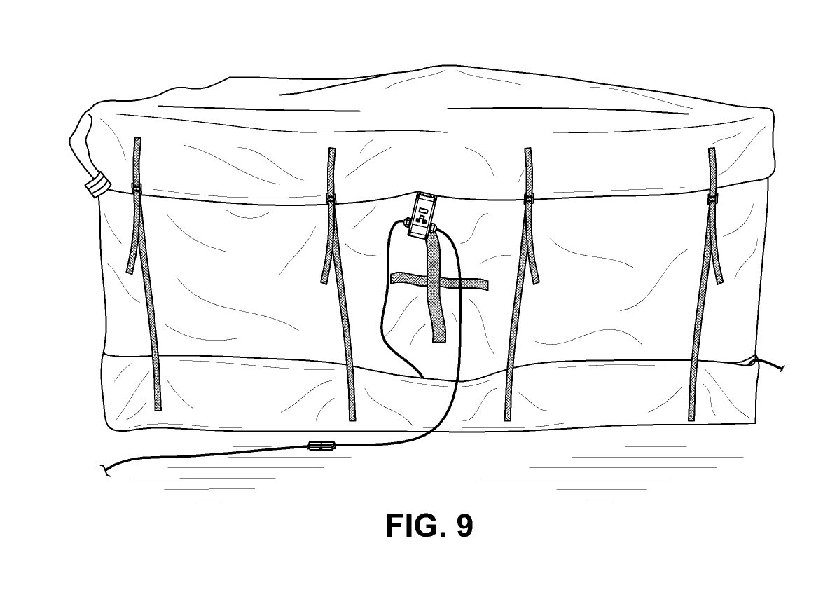

FIG. 9 shows views of an exemplary embodiment of a parasite elimination system in accordance with an embodiment of the present invention. In this embodiment, the securing elements are straps that hold the housing in place over the contaminated area and blanket like structure(s). The control unit is placed outside the housing, while a temperature probe from the control unit is fed into the housing into a central area of the contaminated area.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for eliminating parasites and parasitic insects, said system comprising:
a radiant heat source comprising a blanket like structure and a heating element incorporated within or the blanket like structure such that radiant heat is passed evenly over a surface of the blanket like structure; and
a control unit operably connected to said radiant heat source and configured to engage parasite elimination cleaning cycles.

2. The system of claim 1, wherein the blanket like structure comprises one or more blanket sections, wherein each of said one or more blanket sections may be disconnected from the other blanket sections.

3. The system of claim 2, wherein each of the one or more blanket sections comprises one or more securing elements configured to allow first blanket section of the one or more blanket sections to be secured to a second blanket section.

4. The system of claim 1, further comprising a housing that is configured to envelop the blanket like structure to secure a contaminated area defined inside the blanket like structure such that parasites cannot escape from the contaminated area during a cleaning cycle.

5. The system of claim 3, wherein the housing comprises a flexible non-porous material.

6. The system of claim 3, wherein the housing is constructed from a non-porous flame retardant material.

7. The system of claim 3, wherein the housing comprises a light weight flexible material.

8. The system of claim 1, wherein said control unit is further comprised of control elements allowing for the modification of settings selected from the group comprising temperature range, cleaning cycle time, type of cleaning cycle, type of parasite or parasitic insect targeted and type of area to be cleaned.

9. The system of claim 1, wherein the control unit further comprises a temperature probe, allowing for accurate measurement of the temperatures inside the system during a cleaning cycle.

10. A method for eliminating parasites and parasitic insects, said method comprising the steps of:
placing a blanket like structure over a contaminated area;
engaging a heating element of the blanket like structure such that the surface of the blanket that is in contact with the contaminated area receives radiant heat to an extent great enough to raise a temperature in the contaminated area high enough to kill parasites and parasitic insects within the contaminated area while not damaging other contents of the contaminated area; and
applying the radiant heat from the system for a time period set by and controlled via a control unit, wherein the time period is great enough to kill the parasites and parasitic insects in the contaminated area.

11. The method of claim 10, further comprising the step of securing the blanket like structure in place over the contaminated area so that the area is completely enveloped within the blanket like structure.

12. The method of claim 10, wherein the temperature is greater than 46 degrees Celsius.

13. The method of claim 10, wherein the temperature is between 115 degrees Fahrenheit and 160 degrees Fahrenheit.

14. The method of claim 10, wherein the time period is between 7 and 60 minutes.

15. The method of claim 10, wherein the time period is greater than 7 minutes.

16. The method of claim 10, further comprising the steps of:
determining, via a temperature probe operably attached to the control unit, an ambient temperature in said contaminated area; and
delaying start of said time period until said ambient temperature meets or exceeds said temperature.

17. The method of claim 10, further comprising the steps of:
modifying one or more settings of said control unit via one or more control elements.

18. The method of claim 17, wherein the settings are selected from the group comprising temperature range, cleaning cycle time, type of cleaning cycle, type of parasite or parasitic insect targeted and type of area to be cleaned.
